(19) United States
(12) Patent Application Publication
(10) Pub. No.: US 2023/0075220 A1
(43) Pub. Date: Mar. 9, 2023

(54) OCCUPANCY SENSING MAT FOR VEHICLE SEAT AND VEHICLE SEAT

(71) Applicant: FAURECIA Sièges d'Automobile, NANTERRE (FR)

(72) Inventor: Mamadou BALDE, MORIGNY-CHAMPIGNY (FR)

(21) Appl. No.: 17/940,522

(22) Filed: Sep. 8, 2022

(30) Foreign Application Priority Data
Sep. 9, 2021 (FR) 2109436

(51) Int. Cl. B60N 2/00; B60R 21/015

(52) U.S. Cl. CPC B60N 2/002; B60R 21/01532

(57) ABSTRACT

The present disclosure relates to an occupancy sensing mat for a vehicle seat comprising a flexible support and an occupancy detection sensor carried by the flexible support, the occupancy detection sensor being a capacitive transducer with coplanar interdigitated electrodes comprising a first electrode and a second electrode, the first electrode and the second electrode each comprising a rod and fingers integral with the rod.

### PRIORITY CLAIM

This application claims priority to French Patent Application No. FR2109436, filed Sep. 9, 2021, which is expressly incorporated by reference herein.

### BACKGROUND

The present disclosure relates to the field of detecting seat occupancy. In particular, the present disclosure relates to an occupancy sensing mat for a vehicle seat, and a vehicle seat, in particular of a motor vehicle.

### SUMMARY

According to the present disclosure, an occupancy sensing mat may be used in a vehicle seat, in particular of a motor vehicle. The occupancy sensing mat may comprise at least one flexible support and at least one occupancy detection sensor carried by the flexible support.

In illustrative embodiments, the at least one occupancy detection sensor may be a capacitive transducer with coplanar interdigitated electrodes comprising a first electrode and a second electrode, the first electrode and the second electrode each comprising a rod extending in a longitudinal direction, and fingers integral with the rod, the fingers extending in a transverse direction.

In illustrative embodiments, the fingers of the first electrode may be separated from each other by a same distance, the fingers of the first electrode being interposed between the fingers of the second electrode, a finger of the first electrode being spaced apart from an adjacent finger of the second electrode by a distance comprised between 250 micrometers and 500 micrometers.

In illustrative embodiments, the first electrode and second electrode each including between 15 and 50 fingers and preferably between 23 and 43 fingers; the fingers of at least one electrode, among the first electrode and second electrode, having a dimension in the longitudinal direction comprised between 250 micrometers and 500 micrometers.

In illustrative embodiments, the features set forth in the following paragraphs may optionally be implemented. They may be implemented independently of each other or in combination with each other:
The rod of at least one electrode among the first electrode and second electrode has a dimension in the transverse direction comprised between 50 micrometers and 1000 micrometers, and preferably between 250 micrometers and 500 micrometers.
The fingers of the first electrode have free ends, and a free end of a finger of the first electrode is spaced apart from a rod portion of the second electrode arranged opposite the end, by a spacing comprised between 50 micrometers and 1000 micrometers, and preferably between 250 micrometers and 500 micrometers.
The rod of at least one electrode among the first electrode and second electrode has a thickness comprised between 5 micrometers and 100 micrometers, and preferably between 7 micrometers and 20 micrometers, the thickness being measured in a direction perpendicular to the longitudinal direction and to the transverse direction.
The fingers of at least one electrode among the first electrode and second electrode have a thickness comprised between 5 micrometers and 100 micrometers, and preferably between 7 micrometers and 20 micrometers, the thickness being measured in a direction perpendicular to the longitudinal direction and to the transverse direction.
The fingers of at least one electrode among the first electrode and second electrode have a dimension in the transverse direction comprised between 6 millimeters and 33 millimeters, and preferably between 12 and 24 millimeters.
The rods of at least one electrode among the first electrode and second electrode have a dimension in the longitudinal direction comprised between 110 millimeters and 1020 millimeters, and preferably between 225 millimeters and 500 millimeters.
The second electrode comprises a rod end portion that is without any fingers, the rod end portion being intended to be connected to a conductive track, the length of the rod end portion being between 100 millimeters and 1000 millimeters and preferably between 315 millimeters and 627 millimeters.

In illustrative embodiments, a vehicle seat, in particular of a motor vehicle, comprises a backrest, a seating portion hinged to the backrest, and at least one occupancy detection sensor arranged on the seating portion or the backrest, the at least one occupancy detection sensor being a capacitive transducer with coplanar interdigitated electrodes as mentioned above.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a diagram representing a front view of a capacitive transducer with coplanar interdigitated electrodes of an occupancy sensing mat according to the present disclosure;

FIG. 2 is a diagram representing a section view of a rod of an electrode of the capacitive transducer illustrated in FIG. 1;

FIG. 3 is a diagram representing a front view of an occupancy sensing mat for a vehicle seat according to the present disclosure; and

FIG. 4 is a diagram representing a vehicle seat.

### DETAILED DESCRIPTION

The occupancy sensing mat according to the present disclosure is illustrated on FIG. 3. It comprises at least one flexible support 24 and at least one occupancy detection sensor carried by the flexible support.

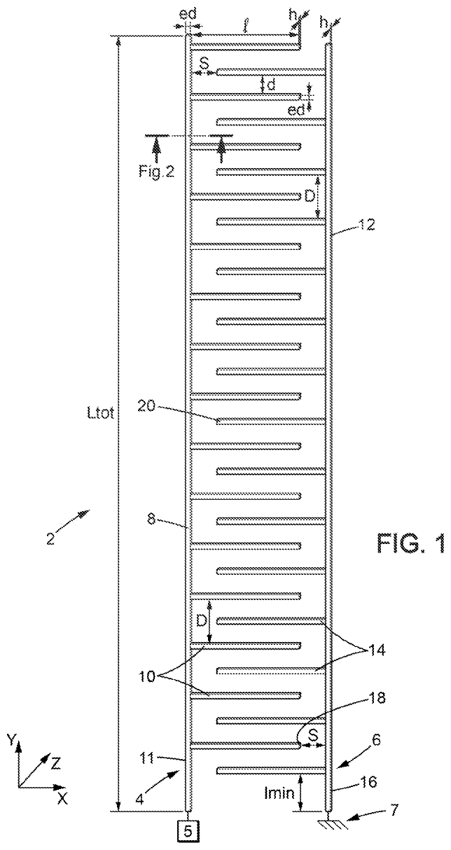

The at least one occupancy detection sensor is a capacitive transducer 2 with coplanar interdigitated electrodes. The capacitive transducer 2 with coplanar interdigitated electrodes has been schematically represented in FIG. 1. It is described with reference to an orthonormal unit vector triad (X, Y, Z).

It comprises a first electrode 4 able to be connected to a voltage source 5 and a second electrode 6 able to be connected to a ground 7.

The voltage source 5 generates a voltage comprised between 5 and 12 volts and preferably a voltage equal to 5 volts.

The first electrode 4 comprises a rod 8 and fingers 10 that are integral with the rod. The fingers 10 extend perpendicularly to the rod, distanced from each other in a comb-shaped configuration. Adjacent fingers 10 of the first electrode are separated from each other by a same distance D. They are distributed all along the rod with the exception of a lower end portion 11 of the rod.

The second electrode 6 is similar to the first electrode. In particular, it comprises a rod 12 and fingers 14. The rod 12 extends parallel to and opposite the rod 8 of the first electrode.

In the embodiment represented in FIG. 1, the first electrode 4 comprises fifteen fingers. Alternatively, the first electrode 4 may comprise between 15 and 50 fingers and preferably between 23 and 43 fingers.

Advantageously, the first electrode 4 comprises 33 fingers. The second electrode 6 preferably comprises the same number of fingers 14 as the number of fingers 10 of the first electrode.

Preferably, the fingers 14 of the second electrode are spaced apart from each other by the same distance D as the distance D between two fingers 10 of the first electrode. The fingers 14 of the second electrode are offset relative to the fingers 10 of the first electrode such that the fingers 14 of the second electrode are interposed between the fingers 10 of the first electrode. Thus, each finger 10 of the first electrode is placed between and at an equal distance d from two fingers 14 of the first electrode. In particular, a finger 10 of the first electrode is spaced apart from an adjacent finger 14 of the second electrode by a distance d comprised between 250 micrometers and 500 micrometers. For example, the distance d is equal to 300 micrometers.

The first electrode 4 and the second electrode 6 comprise a rod end portion 11, 16 that is without any fingers. This end portion 11, 16 does not have the same length in the first electrode and in the second electrode, due to the offset in position between the fingers 10 of the first electrode and the fingers 14 of the second electrode.

In the embodiment shown in FIG. 1, the end portion 16 of the second electrode 6 has a length 1 min that is less than the length of the end portion 11 of the first electrode. This length 1 min is between 100 millimeters and 1000 millimeters and preferably between 315 millimeters and 627 millimeters. This length 1 min is measured between the free end of the rod which is intended to be connected to a conductive track and the finger 14 closest to this free end.

The fingers 10 of the first electrode have free ends 18. A free end 18 of a finger of the first electrode is spaced apart from a rod portion of the second electrode arranged opposite the end, by a spacing S comprised between 50 micrometers and 1000 micrometers, and preferably between 250 micrometers and 500 micrometers. This spacing S is measured in the transverse direction X. This spacing S is identical to the distance d between a finger 10 of the first electrode and an adjacent finger 14 of the second electrode, the distance d being measured in the longitudinal direction Y. The same spacing S is also provided between the ends 20 of the fingers 14 of the second electrode and a rod portion of the first electrode arranged opposite each end.

The rod 8 of the first electrode is identical to the rod 14 of the second electrode. Only the rod of the first electrode is described in detail below.

The rod 8 extends in a longitudinal direction Y. It has a dimension Ltot in the longitudinal direction Y comprised between 110 millimeters and 1020 millimeters, and preferably between 225 millimeters and 500 millimeters.

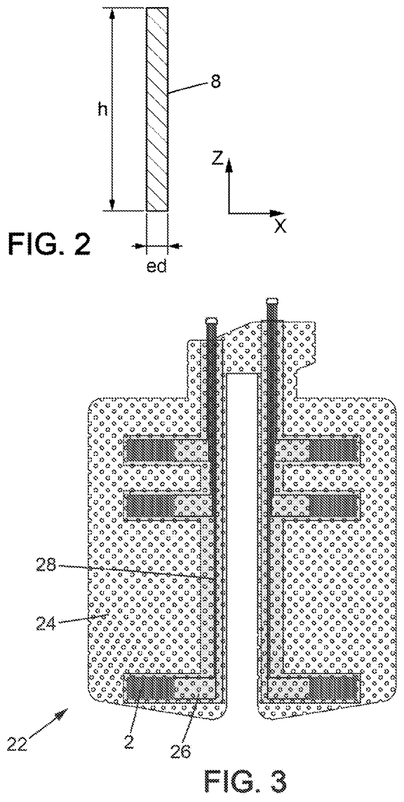

In the embodiment shown, the rod 8 has a rectangular section. As can be seen in FIG. 2 representing a section view of the rod, the rod 8 has a dimension ed in the transverse direction X comprised between 250 micrometers and 500 micrometers. Advantageously, the rod 8 has a dimension equal to 300 micrometers.

The rod has a thickness h comprised between 5 micrometers and 100 micrometers. The thickness h is measured in a direction Z perpendicular to the longitudinal direction Y and to the transverse direction X. Preferably, the thickness of the rod is between 7 micrometers and 20 micrometers. Advantageously, the thickness of the rod is equal to 10 micrometers.

Alternatively, the section of the rod may be circular, trapezoidal, or any other shape.

In the embodiment represented, the fingers 10 of the first electrode are identical to the fingers 14 of the second electrode.

The fingers 10 of the first electrode and the fingers 14 of the second electrode have the same section as the rod 8. Thus, the dimension ed of a finger 10, 14 in a longitudinal direction Y has the same length as the dimension ed of a rod in the transverse direction X.

Alternatively, the dimension ed of a finger 10, 14 in a longitudinal direction Y has a different length than the dimension ed of a rod in the transverse direction X.

Thus, the fingers 10, 14 have a dimension ed in the longitudinal direction Y comprised between 50 micrometers and 1000 micrometers, and preferably between 250 micrometers and 500 micrometers. Advantageously, the fingers 10, 14 have a dimension ed equal to 300 micrometers.

In the same manner, the thickness h of the fingers 10, 14 in direction Z is identical to the thickness h of the rods in direction Z. Thus, the fingers 10, 14 have a thickness h comprised between 5 micrometers and 100 micrometers, and preferably between 7 micrometers and 20 micrometers. Advantageously, the thickness of the fingers 10, 14 is equal to 10 micrometers.

Finally, the fingers 10, 14 have a dimension 1 in the transverse direction X comprised between 6 millimeters and 33 millimeters, and preferably between 12 and 24 millimeters. This range of lengths makes it possible to obtain a detection signal of large amplitude. Advantageously, this dimension makes it possible to differentiate the morphological type of the occupant of a seat, namely whether it is a child, a rather thin adult, or a person of significant weight.

Advantageously, the dimension 1 of the fingers in the transverse direction X is equal to 18 millimeters.

Alternatively, the length of the fingers 14 in the transverse direction X of the second electrode is different from the length of the fingers 10 of the first electrode in the same direction.

Referring to FIG. 3, the occupancy sensing mat 22 for detecting the occupancy of a vehicle seat, comprises a first flexible support 24, a second flexible support 26 fixed to the first flexible support, and capacitive transducers 2 with coplanar interdigitated electrodes carried by the second flexible support 26.

The first flexible support 24 may be a woven or non-woven support made of natural fibers or synthetic fibers. It is also possible for it to be made of plastic. In the embodiment shown in FIG. 3, the first flexible support 24 is perforated to allow the passage of air from a seat ventilation system.

The second flexible support 26 may be made of a resin or a plastic material such as thermoplastic polyurethane referred to by the acronym TPU, polyethylene terephthalate referred to by the acronym PET, polycarbonate referred to by the acronym PC, or polyamide.

The capacitive transducers 2 with interdigitated electrodes and the conductive tracks 28 are fixed on the upper face of the second flexible support. In FIG. 3, the capacitive transducers have been schematically represented by a rectangle. They are implemented by electronic printing or sewing. The capacitive transducers 2 with interdigitated electrodes form occupancy detection sensors.

Heating elements, not shown, may also be fixed on the first flexible support 24.

According to a variant not shown, the occupancy sensing mat 22 comprises only one flexible support. In such case the capacitive transducers 2 with interdigitated electrodes, the conductive tracks 28, and possibly the heating elements are fixed on this single flexible support.

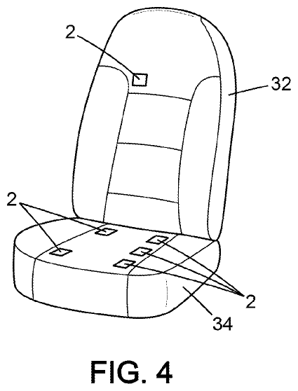

The present disclosure also relates to a vehicle seat, in particular a motor vehicle seat. The seat 30 comprises a backrest 32, a seating portion 34 hinged to the backrest, and occupancy detection sensors arranged on the seating portion and/or on the backrest. The occupancy detection sensors are capacitive transducers 2 with coplanar interdigitated electrodes in accordance with the above. In FIG. 4, the capacitive transducers 2 with interdigitated electrodes are represented schematically by squares.

Capacitive transducers with coplanar interdigitated electrodes may be used for biological applications such as the detection of bacteria in food samples or the detection of the H5N1 avian influenza virus. These sensors may also be used for detecting cancer cells or for analyzing parasites in polluted water. In all these uses, the capacitive transducers with interdigitated electrodes are suitable for detecting microparticles in a liquid.

In one comparative example, a capacitive transducer with interdigitated electrodes may be used to detect the presence of an occupant on a seat of a motor vehicle. However, the detection lacked precision because in that use, the comparative capacitive transducer with interdigitated electrodes was placed between two layers of foam and must detect pressure exerted on it, not microparticles in a liquid. The present disclosure aims to improve the detection of the presence of an occupant on a seat, using a capacitive transducer with interdigitated electrodes.

The present disclosure relates to an occupancy sensing mat (22) for a vehicle seat comprising a flexible support (24, 26) and an occupancy detection sensor carried by the flexible support, the occupancy detection sensor being a capacitive transducer (2) with coplanar interdigitated electrodes comprising a first electrode and a second electrode, the first electrode and the second electrode each comprising a rod and fingers integral with the rod; the fingers of the first electrode being separated from each other by a same distance, the fingers of the first electrode being interposed between the fingers of the second electrode, a finger of the first electrode being spaced apart from an adjacent finger of the second electrode by a distance comprised between 250 micrometers and 500 micrometers; the first electrode and the second electrode each including between 15 and 50 fingers; the fingers of an electrode having a dimension comprised between 250 micrometers and 500 micrometers.

1. An occupancy sensing mat for a vehicle seat, in particular of a motor vehicle, the occupancy sensing mat comprising
at least one flexible support and at least one occupancy detection sensor carried by the flexible support, the at least one occupancy detection sensor being a capacitive transducer with coplanar interdigitated electrodes comprising a first electrode and a second electrode, the first electrode and the second electrode each comprising a rod extending in a longitudinal direction, and fingers integral with the rod, the fingers extending in a transverse direction;
the fingers of the first electrode being separated from each other by a same distance, the fingers of the first electrode being interposed between the fingers of the second electrode, a finger of the first electrode being spaced apart from an adjacent finger of the second electrode by a distance comprised between 250 micrometers and 500 micrometers;
the first electrode and second electrode each including between 15 and 50 fingers and preferably between 23 and 43 fingers;
the fingers of the at least one electrode, among the first electrode and second electrode, having a dimension in the longitudinal direction comprised between 250 micrometers and 500 micrometers.

2. The occupancy sensing matter of claim 1, wherein the rod of at the least one electrode among the first electrode and second electrode has a dimension in the transverse direction comprised between 50 micrometers and 1000 micrometers, and preferably between 250 micrometers and 500 micrometers.

3. The occupancy sensing matter of claim 1, wherein the fingers of the first electrode have free ends, and wherein a free end of a finger of the first electrode is spaced apart from a rod portion of the second electrode arranged opposite the end, by a spacing comprised between 50 micrometers and 1000 micrometers, and preferably between 250 micrometers and 500 micrometers.

4. The occupancy sensing matter of claim 1, wherein the rod of the at least one electrode among the first electrode and second electrode has a thickness comprised between 5 micrometers and 100 micrometers, and preferably between 7 micrometers and 20 micrometers, the thickness being measured in a direction perpendicular to the longitudinal direction and to the transverse direction.

5. The occupancy sensing matter of claim 1, wherein the fingers of at least one electrode among the first electrode and second electrode have a thickness comprised between 5 micrometers and 100 micrometers, and preferably between 7 micrometers and 20 micrometers, the thickness being measured in a direction perpendicular to the longitudinal direction and to the transverse direction.

6. The occupancy sensing matter of claim 1, wherein the fingers of the at least one electrode among the first electrode and second electrode have a dimension in the transverse direction comprised between 6 millimeters and 33 millimeters, and preferably between 12 and 24 millimeters.

7. The occupancy sensing matter of claim 1, wherein the rods of at least one electrode among the first electrode and second electrode have a dimension in the longitudinal direction comprised between 110 millimeters and 1020 millimeters, and preferably between 225 millimeters and 500 millimeters.

8. The occupancy sensing matter of claim 1, wherein the second electrode comprises a rod end portion that is without any fingers, the rod end portion being intended to be connected to a conductive track, the length of the rod end portion being between 100 millimeters and 1000 millimeters and preferably between 315 millimeters and 627 millimeters.

9. A vehicle seat, in particular of a motor vehicle, comprising:
a backrest,
a seating portion hinged to the backrest,
at least one occupancy detection sensor arranged on the seating portion or backrest, the at least one occupancy detection sensor being in accordance with claim 1.
